(19) United States
(12) Patent Application Publication
(10) Pub. No.: US 2007/0022225 A1
(43) Pub. Date: Jan. 25, 2007

(54) Memory DMA interface with checksum

(75) Inventors: Rajesh Nair, Fremont, CA (US); Komal Rathi, Sunnyvale, CA (US); Caveh Jalali, Redwood City, CA (US)

Correspondence Address: MARGER JOHNSON & MCCOLLOM, P.C., 210 SW MORRISON STREET, SUITE 400, PORTLAND, OR, 97204, US

(73) Assignee: Mistletoe Technologies, Inc., Cupertino, CA (US)

(21) Appl. No.: 11/187,055

(22) Filed: Jul. 21, 2005

(51) Int. Cl. G06F 13/28

(52) U.S. Cl. 710/22

(57) ABSTRACT

A system and method comprising a direct memory access (DMA) circuit configured to directly access a memory, and a checksum adder configured to determine a checksum for data transferred between the DMA circuit and the memory.

### REFERENCE TO RELATED APPLICATIONS

Copending, commonly-assigned U.S. patent application Ser. Nos. 10/351,030 and 11/127,445, filed on Jan. 24, 2003 and May 11, 2005, respectively, are incorporated herein by reference.

### FIELD OF THE INVENTION

This invention relates generally to memory interfaces, and more specifically to determining checksums during direct memory access (DMA) operations.

### BACKGROUND OF THE INVENTION

In the data communications field, a packet is a finite-length (generally several tens to several thousands of octets) digital transmission unit comprising one or more header fields and a data field. The data field may contain virtually any type of digital data. The header fields convey information (in different formats depending on the type of header and options) related to delivery and interpretation of the packet contents. This information may, e.g., identify the packet's source or destination, identify the protocol to be used to interpret the packet, identify the packet's place in a sequence of packets, aid packet flow control, or provide error detection mechanisms such as checksums.

A checksum is an unsigned 16-bit value determined by performing 1's compliment addition on data within a packet. Typical packet receivers store packets to memory and then perform error checking functions including the calculation of the checksum. The calculation of checksums, however, can be time-consuming, thus slowing the processing of the packets and overall operation of the receivers.

### DESCRIPTION OF THE DRAWINGS

The invention may be best understood by reading the disclosure with reference to the drawings, wherein:

FIG. 1 illustrates, in block form, a memory system useful with embodiments of the present invention;

FIG. 2 illustrates, in block form, one possible implementation of the DMA interface shown in FIG. 1;

FIG. 3A shows, in block form, one example of the data flow through the memory system shown in FIG. 1;

FIG. 3B shows, in block form, another example of the data flow through the memory system shown in FIG. 1;

FIG. 4 shows an example flow chart illustrating embodiments for operating the DMA interface shown in FIG. 1; and

FIG. 5 illustrates, in block form, a reconfigurable semantic processor useful with embodiments of the DMA interface shown in FIG. 1.

### DETAILED DESCRIPTION

Data verification or redundancy checking with checksums is commonly used to detect errors in data received from networks or peripheral devices. The addition of a checksum adder to a direct memory access (DMA) interface allows for the computation of checksums during direct memory access operations, thus reducing the latency incurred in the subsequent error detection. Embodiments of the present invention will now be described in more detail.

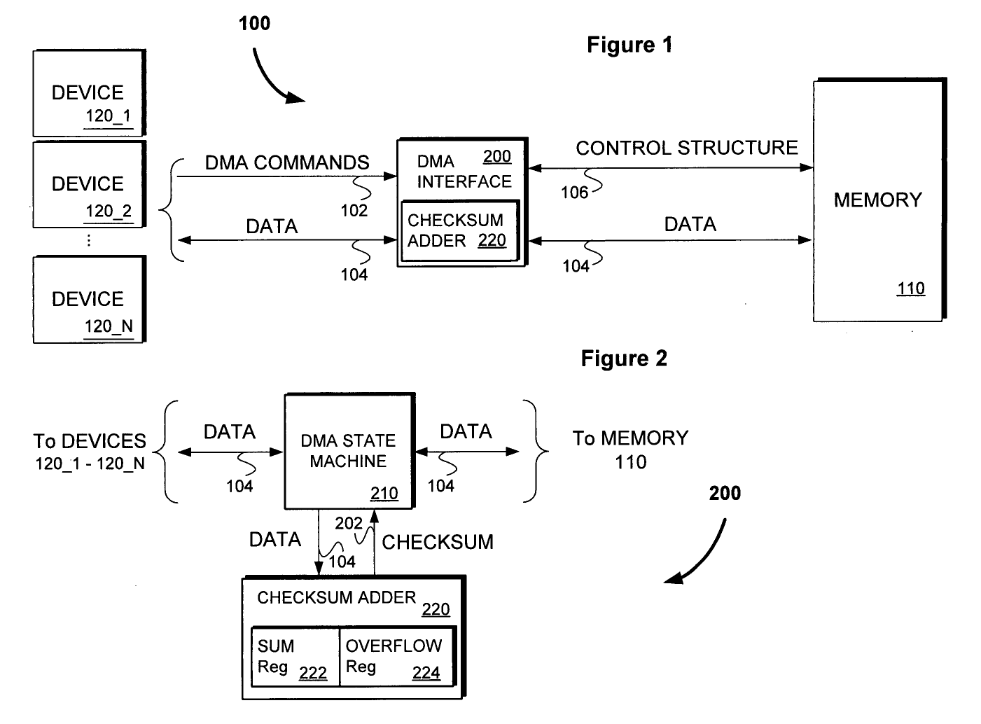

FIG. 1 illustrates, in block form, a memory system 100 useful with embodiments of the present invention. The memory system 100 includes a DMA interface 200 coupled between a memory 110 and a plurality of devices 120_1 to 120_N. The DMA interface 200 is configured to directly access a memory 110 according to DMA commands 102 provided by one or more of the devices 120_1 to 120_N. The DMA commands 102, when executed, direct the DMA interface 200 to load data 104 from a source, e.g., the memory 110 or the devices 120_1 to 120_N, and store the loaded data 104 to a destination, e.g., the memory 110 or the devices 120_1 to 120_N. For instance, in DMA reading operations, the DMA interface 200 loads data 104 from the memory 110 and stores the loaded data 104 to one or more of the devices 120_1 to 120_N. In DMA writing operations, the DMA interface 200 loads data 104 from one or more of the devices 120_1 to 120_N and stores the loaded data 104 to memory 110.

The DMA commands 102 include a source address field for specifying the source of data 104 to be loaded by the DMA interface 200, a destination address field for identifying the destination of the loaded data 104, and size fields for indicating the length of the data 104 to be accessed. The DMA commands 102 may include other fields and/or prompt other DMA interface 200 functionality, selected examples will be described below in detail.

The DMA interface 200 loads and stores control structures 106 that include information about the data 104 stored in memory 110, e.g., checksums or partial checksums of the data 104, gap variables indicating the validity of certain segments of the data 104, size parameters identifying the length of the data 104, and/or pointers to the locations in memory 110 where the data 104 is stored. The control structures 106 may be loaded or stored according to the same DMA commands 102 that direct the DMA interface 200 to load and store the data 104. For instance, in DMA reading operations, the DMA interface 200 may load a control structure 106 from memory 110 according to the one or more DMA commands 102, and subsequently load the data 104 according to the pointers within the control structure 106. In some embodiments the control structures 106 may be loaded or stored according to DMA commands 102 different from the DMA commands 102 that direct the DMA interface 200 to load and store the data 104.

The DMA interface 200 determines the checksums or partial checksums of the data 104 as the data 104 is stored to the memory 110. For instance, when storing data 104 according to DMA commands 102, a checksum adder 220 within the DMA interface 200 computes a checksum or partial checksums of the data 104. The computed checksum or partial checksums may be included in the control structures 106 to be stored to the memory 110. In some embodiments, the DMA commands 102 include a field to indicate whether the DMA interface 200 is to include certain segments of the data 104 during checksum computation. Thus the DMA interface 200 may selectively checksum segments of the data 104 according to the DMA commands 102 as the data 104 is being stored to memory 110. When the DMA interface 200 is to checksum data 104 that is less than a full data word used by the checksum adder 220, which may occur at the end of a data frame or when selectively checksumming segments of data 104, the DMA interface 200 may add padding to the data 104 in order to complete the data word.

Although FIG. 1 shows only one DMA interface 200 for loading and storing the control structures 106 and the data 104, multiple DMA interfaces 200 may be incorporated into memory system 100. In some embodiments the multiple DMA interfaces 200 may cooperate to perform the functionality of a single DMA interface. For example, a first DMA interface 200 may store data 104 to the memory 110 and compute a corresponding checksum or partial checksums. The first DMA interface then sends the checksum or partial checksums to a second DMA interface 200 to be incorporated into a control structure 106 that corresponds to the data 104 stored by the first DMA interface 200.

For descriptive convenience, the memory 110 is shown in FIG. 1 as a monolithic addressable memory space, however, in some embodiments the memory 10 may be bifurcated to store the data 104 and the control structures 106 separately, or configured as a plurality of memory devices. In some embodiments, the DMA commands 102 control the loading and storing of data 104 with memory 110, while other commands (not shown) control the loading and storing of data 104 with the devices 120_1 to 120_N. Both sets of commands may be provided directly to the DMA interface 200 by the devices 120_1 to 120_N.

FIG. 2 illustrates, in block form, one possible implementation of the DMA interface 200 shown in FIG. 1. Referring to FIG. 2, the DMA interface 200 includes a DMA state machine 210 to perform operations specified by the DMA commands 102. The DMA state machine 210 includes two main states, a load state and a store state. During a load state, the DMA state machine 210 loads data 104 from memory 110 or at least one device 120_1 to 120_N. During a store state, the DMA state machine 210 stores the data 104 to memory 110 or at least one device 120_1 to 120_N. The DMA state machine 210 transitions between the states according to DMA commands 102.

The DMA interface 200 includes a checksum adder 220 to determine a checksum 202 of loaded data 104. The DMA state machine 210 may provide the loaded data 104 to the checksum adder 220 in a store state. The checksum adder 220 includes a sum register 222 and an overflow register 224 used to compute the checksum 202 of the data 104. The checksum adder 220 performs a 1's compliment addition on the data 104 and stores the sum within the sum register 222 and an overflow, if present, to the overflow register 224. The checksum adder 210 adds the overflow and the sum to generate the checksum 202 and provides the computed checksum 202 to the DMA state machine 210. The DMA state machine 210 may store the checksum 202 to memory 110 according to DMA commands 102, or provide the checksum 202 to another DMA interface 200 for storing to memory 110.

The DMA interface 200 may determine partial checksums of the data 104 similarly to determining the entire checksum 202. For instance, the DMA state machine 210 provides portions of data 104 to checksum adder 220 to determine a checksum corresponding to those data portions. Since the determined checksum does not correspond to all of the data 104, it is a partial checksum. After the DMA interface 200 determines all of the partial checksums, they may be added to generate the checksum 202, or stored to memory 110 in a control structure 106.

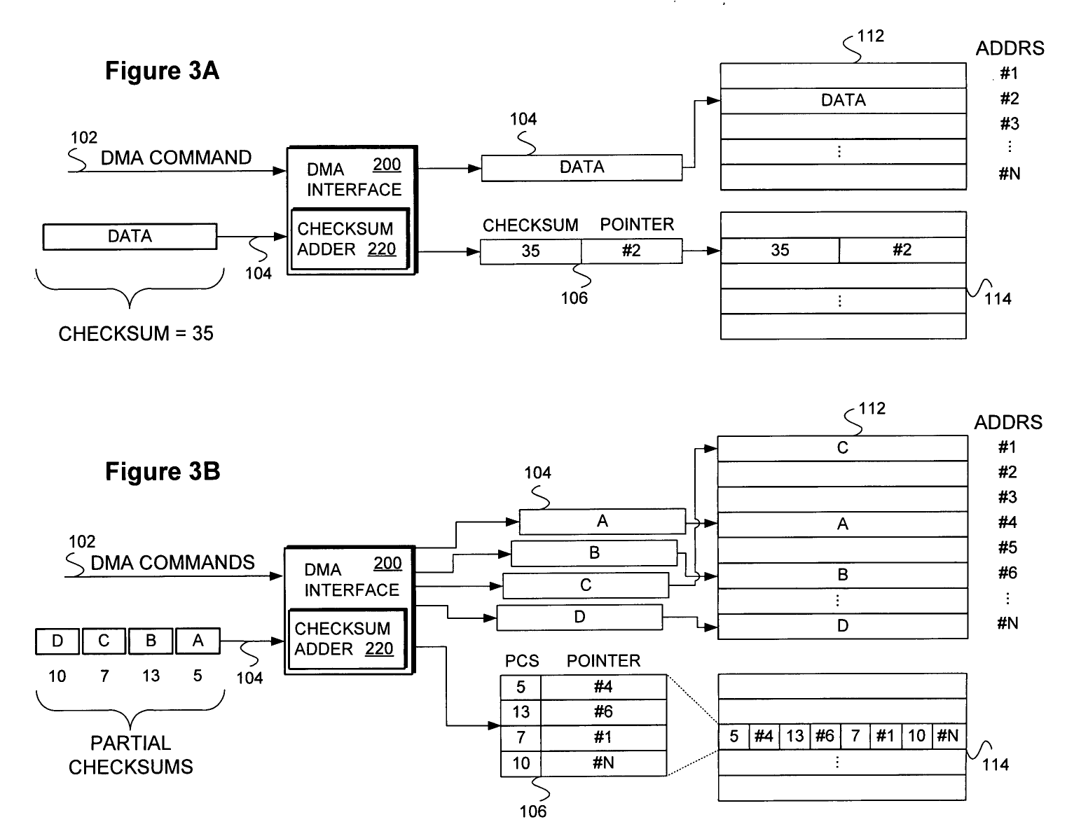

FIGS. 3A and 3B show, in block form, examples of the data flow through the memory system 100 shown in FIG. 1. Referring to FIG. 3A, DMA interface 200 receives a DMA command 102 from one of the devices 120_1 to 120_N. The DMA command 102 directs the DMA interface to load data 104 and to store it to address location #2 within memory 112. When computed the loaded data 104 has a checksum equal to 35. In some instances, the data 104 may not completely fill address location #2 in memory 112, leaving a gap of invalid data. When this situation arises, the DMA interface 200 may provide a gap variable within control structure 106 to indicate where the data 104 ends and the gap of invalid data begins. The use of the gap variable allows for proper correlation between the checksum within control structure 106 and the data 104 stored in memory 112.

The DMA interface 200 determines the checksum of the loaded data 104 with a checksum adder 220 as the data 104 is being stored to memory 112 by the DMA interface 200. The DMA interface 200 incorporates the checksum into a control structure 106 with other control fields, e.g., a pointer corresponding to the location of the data 104 in memory 112, and stores the control structure 106 to a memory 114. Although memories 112 and 114 are shown as distinct sets of contiguous addressable memory locations or distinct memory devices, they may be commingled or interweaved within any portion of memory 110.

The data flow in FIG. 3B is similar to that in FIG. 3A except FIG. 3B stores data 104 to memory 112 in multiple DMA operations. Referring to FIG. 3B, DMA interface 200 receives a plurality of DMA commands 102 from at least one of the devices 120_1 to 120_N. The DMA commands 102 direct the DMA interface 200 to separately load portions of the data A-D, e.g., portions A, B, C, and D, and to separately store them to various address locations within memory 112. For instance, a first DMA command 102 directs the DMA interface 200 to load and store portion A of data 104, a second DMA command 102 directs the DMA interface 200 to load and store portion B of data 104, etc., until all of the portions of data 104 are stored to memory 110. When computed the data 104 has partial checksums equal to 5, 13, 7, and 10 corresponding to portions A, B, C, and D, respectively.

The DMA interface 200 determines partial checksums of the data portions A-D with a checksum adder 220 as the data portions A-D are stored to memory 112 by the DMA interface 200. The DMA interface incorporates the partial checksums into a control structure 106 with other control fields, e.g., pointers corresponding to the locations of the data portions A-D in memory 112, and stores the control structure 106 to a memory 114. The control structure 106 may be stored to memory 114 after all of the partial checksums are computed, or stored after the first partial checksum is computed and subsequently updated with the computations of successive partial checksums.

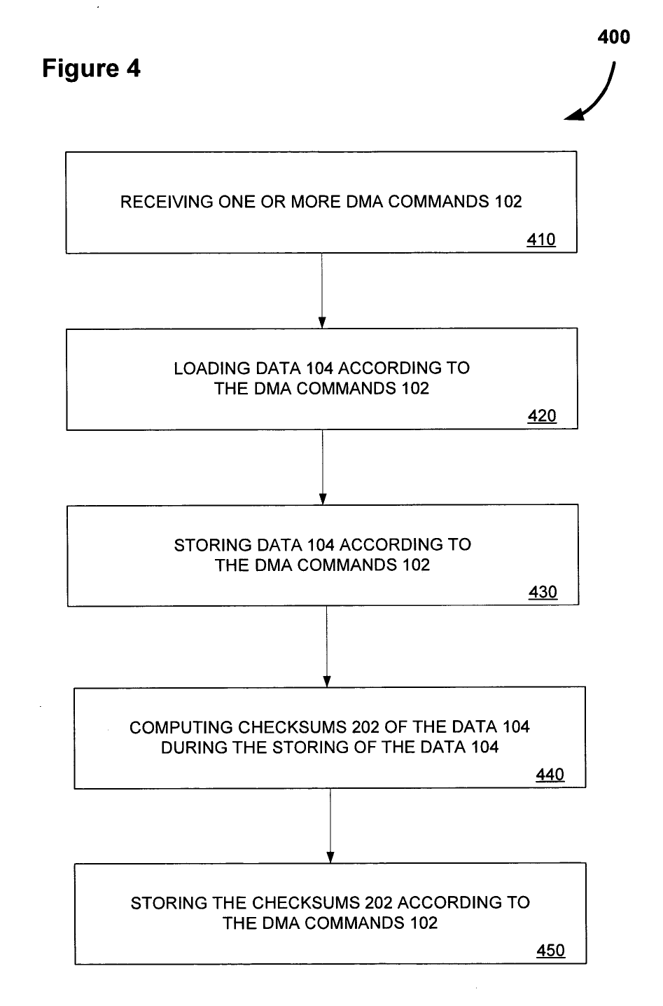

FIG. 4 shows an example flow chart illustrating embodiments for operating the DMA interface 200 shown in FIG. 1. According to a block 410, the DMA interface 200 receives one or more DMA commands 102. The DMA commands 102 may be provided by one or more of the devices 120_1 to 120_N.

According to next block 420, the DMA interface 200 loads data 104 according to the DMA commands 102. The DMA interface 200 may load data 104 from one or more of the devices 120_1 to 120_N or from memory 110 in response to the DMA commands 102. Depending on the size of the data 104 and the specifications of the system 100, the data 104 may be loaded in one DMA command 102 or with multiple DMA commands 102.

According to next block 430, the DMA interface 200 stores the loaded data 104 according to the DMA commands 102. The DMA interface 200 may store data 104 to one or more of the devices 120_1 to 120_N or to memory 110 in response to the DMA commands 102. Depending on the size of the data 104 and the specifications of the system 100, the data 104 may be loaded in one DMA command 102 or with multiple DMA commands 102. In blocks 420 and 430 when the data 104 is loaded and stored with multiple DMA commands, the DMA interface 200 may load and store a portion of the data 104 before the subsequent portion of data 104 is loaded and stored. Thus for a large data 104 segment, multiple load-store combinations may be used to transfer the packet between memory 110 and devices 120_1 to 120_N.

According to next block 440, the DMA interface 200 computes at least one checksum 202 of the data 104 as the DMA interface 200 stores the loaded data 104. The DMA interface 200 may include a checksum adder 220 to compute the checksum 202 of the data 104. When data 104 requires multiple DMA commands 102 to store the data 104, partial checksums of the data 104 may be computed by the DMA interface 200. These partial checksums, when added, result in the checksum 202 of the data 104.

According to next block 450, the DMA interface 200 stores the checksum 202 according to the DMA commands 102. When in block 440 the DMA interface 200 computes partial checksums, the partial checksums may be stored according to the DMA commands 102. The DMA interface 200 may store the checksum 202 or partial checksums by incorporating them in a control structure 106 and storing the control structure to memory 110 according to DMA commands 102.

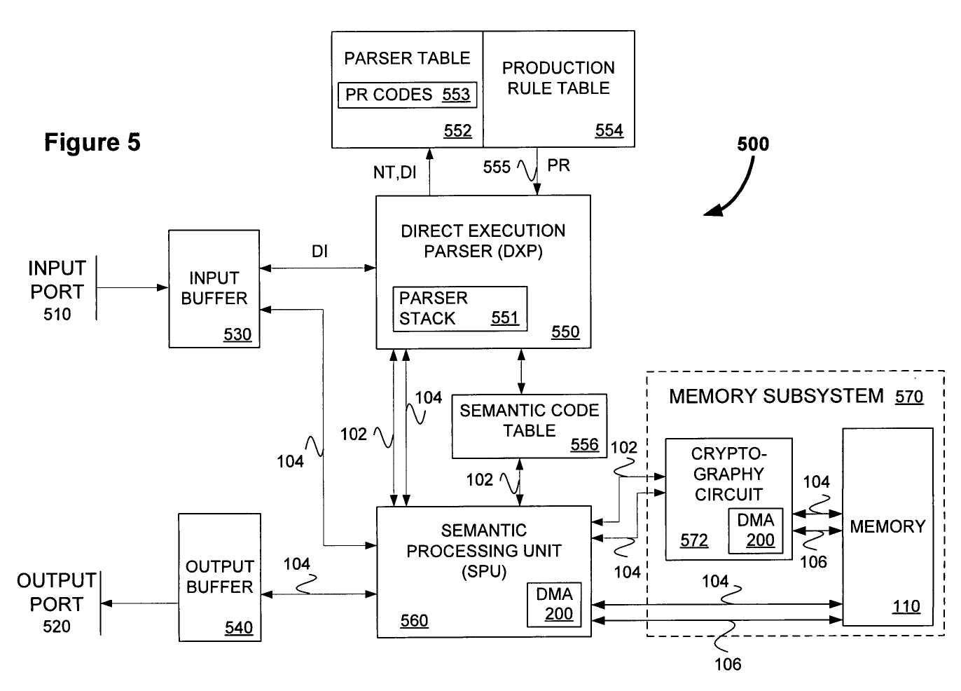

FIG. 5 illustrates, in block form, a reconfigurable semantic processor useful with embodiments of the DMA interface 200 shown in FIG. 1. Referring to FIG. 5, the reconfigurable semantic processor 500 contains an input buffer 530 for buffering data streams received through the input port 510, and an output buffer 540 for buffering data steams to be transmitted through output port 520. Input 510 and output port 520 may comprise a physical interface to network 120 (FIGS. 1 and 2), e.g., an optical, electrical, or radio frequency driver/receiver pair for an Ethernet, Fibre Channel, 802.11x, Universal Serial Bus, Firewire, SONET, or other physical layer interface. A platform implementing at least one reconfigurable semantic processor 500 may be, e.g., PDA, Cell Phone, Router, Access Point, Client, or any wireless device, etc., that receives packets or other data streams over a wireless interface such as cellular, CDMA, TDMA, 802.11, Bluetooth, etc.

Semantic processor 500 includes a direct execution parser (DXP) 550 that controls the processing of packets in the input buffer 530 and a semantic processing unit (SPU) 560 for processing segments of the packets or for performing other operations. The DXP 550 maintains an internal parser stack 551 of non-terminal (and possibly also terminal) symbols, based on parsing of the current input frame or packet up to the current input symbol. When the symbol (or symbols) at the top of the parser stack 551 is a terminal symbol, DXP 550 compares data DI at the head of the input stream to the terminal symbol and expects a match in order to continue. When the symbol at the top of the parser stack 551 is a non-terminal (NT) symbol, DXP 550 uses the non-terminal symbol NT and current input data DI to expand the grammar production on the stack 551. As parsing continues, DXP 550 instructs a SPU 560 to process segments of the input, or perform other operations.

Semantic processor 500 uses at least three tables. Code segments for SPU 560 are stored in semantic code table 556. Complex grammatical production rules are stored in a production rule table (PRT) 554. Production rule (PR) codes 553 for retrieving those production rules are stored in a parser table (PT) 552. The PR codes 553 in parser table 552 also allow DXP 550 to detect whether, for a given production rule, a code segment from semantic code table 556 should be loaded and executed by SPU 560.

The production rule (PR) codes 553 in parser table 552 point to production rules in production rule table 554. PR are stored, e.g., in a row-column format or a content-addressable format. In a row-column format, the rows of the table are indexed by a non-terminal symbol NT on the top of the internal parser stack 551, and the columns of the table are indexed by an input data value (or values) DI at the head of the input. In a content-addressable format, a concatenation of the non-terminal symbol NT and the input data value (or values) DI can provide the input to the parser table 552. Preferably, semantic processor 500 implements a content-addressable format, where DXP 550 concatenates the non-terminal symbol NT with 8 bytes of current input data DI to provide the input to the parser table 552. Optionally, parser table 552 concatenates the non-terminal symbol NT and 8 bytes of current input data DI received from DXP 550.

The semantic processor 500 includes a memory subsystem 570 for storing or augmenting segments of the packets. The memory system 570 includes the memory 110 to be accessed in direct memory access operations SPU 560. The SPU 560 includes a DMA interface 200 to directly access the memory 110 in response to DMA commands stored in the semantic code table 556. The SPU 560 may retrieve the DMA commands directly from the semantic code table 556 when prompted by the DXP 550, or they may be provided to the SPU 560 by the DXP 550 or a dispatcher (not shown) when multiple SPUs 550 are incorporated in semantic processor 500. The DMA commands 102 can be initiated according to the production rules output by PRT 554 pursuant to the parsing performed in parser table 552. The production rule 555 then launches SEP code in SCT 556 that contains the DMA commands 102 that cause the DMA interface 200 to automatically generate the checksum 202 and transfer the checksum to memory 110. The DMA commands, when executed, allow the SPU 560 to transfer data between the memory 110 and the input buffer 530, output buffer 540, or DXP 550.

The memory subsystem 570 includes a cryptography circuit 572 to perform cryptography operations on data, including encryption, decryption, and authentication, when directed by SPU 560. The cryptography circuit 572 includes a DMA interface 200 to directly access the memory 110 in response to DMA commands provided by the SPU 560. The DMA commands, when executed, allow the SPU 560 to transfer data between the memory 110 and the SPU 560, or to return the data to the memory 110.

One skilled in the art will recognize that the concepts taught herein can be tailored to a particular application in many other advantageous ways. In particular, those skilled in the art will recognize that the illustrated embodiments are but one of many alternative implementations that will become apparent upon reading this disclosure.

The preceding embodiments are exemplary. Although the specification may refer to “an”, “one”, “another”, or “some” embodiment(s) in several locations, this does not necessarily mean that each such reference is to the same embodiment(s), or that the feature only applies to a single embodiment.

What is claimed is:

1. A device comprising:
a direct memory access (DMA) circuit configured to directly access a memory; and
a checksum adder configured to determine a checksum for data transferred between the DMA circuit and the memory.

2. The device according to claim 1 wherein the DMA circuit and the checksum adder are incorporated in a cryptography circuit for performing cryptography operations, including encryption, decryption, or authentication.

3. The device according to claim 1 wherein the DMA circuit and the checksum adder are incorporated in a semantic processor for performing data operations according to instructions from a semantic code table.

4. The device according to claim 1 wherein the DMA circuit is configured to store the checksum in a section of the memory containing control information for the data stored in a memory.

5. The interface according to claim 4 wherein the DMA circuit is configured to access the checksum when the data is read from the memory.

6. The device according to claim 1 wherein the DMA circuit directly stores portions of the data to the memory and the checksum adder determines partial checksums for each of the data portions as they are stored to the memory by the DMA circuit.

7. The device according to claim 6 wherein the DMA circuit is configured to store the partial checksums corresponding to the stored data portions in the memory.

8. The device according to claim 1 wherein the DMA circuit selectively provides the checksum adder with the data used for determining the checksum.

9. The device according to claim 1 wherein the DMA circuit and the checksum adder are part of a same DMA circuit.

10. The device according to claim 1 wherein the checksum adder determines the checksum for data stored to the memory or for data loaded from the memory.

11. A system comprising:
a semantic code table populated with direct memory access (DMA) commands;
a semantic processing unit configured to perform direct memory access operations according to the DMA commands from the semantic code table, the semantic processing unit including a checksum adder that determines a checksum for data stored during the direct memory access operations.

12. The system of claim 11 including a cryptography circuit that performs cryptography operations including encryption, decryption, or authentication, wherein the cryptography circuit is configured to perform direct memory access operations according to the DMA commands.

13. The system of claim 12 wherein the semantic processing unit provides the DMA commands to the cryptography circuit.

14. The system of claim 12 wherein the cryptography circuit includes a checksum adder that determines a checksum for data stored during the direct memory access operations.

15. The system of claim 11 including a direct execution parser causing the semantic processing unit to execute one or more of the DMA commands stored within the semantic code table.

16. A method comprising:
performing direct memory access operations according to one or more direct memory access (DMA) commands; and
determining checksums for data stored during the direct memory access operations.

17. The method of claim 16 including
loading the data from a device to a checksum circuit according to the DMA commands; and
storing a resulting checksum from the checksum circuit to a memory according to the DMA commands.

18. The method of claim 16 including
loading the data from a memory to a checksum circuit according to the DMA commands; and
sending a resulting checksum from the checksum circuit to a device according to the DMA commands.

19. The method of claim 16 including storing the checksum to a memory.

20. The method of claim 16 including determining a plurality of partial checksums for different portions of the data during the direct memory access operations.

21. The method of claim 16 including
selecting data to be used in determining the checksums according to the DMA commands; and
determining the checksums with the selected data.
